(19) United States
(12) Patent Application Publication
(10) Pub. No.: US 2008/0019787 A1
(43) Pub. Date: Jan. 24, 2008

(54) Drill for machining fiber reinforced composite material

(76) Inventors: Karthikeyan Sampath, Latrobe, PA (US); Wangyang Ni, Latrobe, PA (US)

Correspondence Address: KENNAMETAL INC., P.O. BOX 231, 1600 TECHNOLOGY WAY, LATROBE, PA, 15650, US

(21) Appl. No.: 11/491,637

(22) Filed: Jul. 24, 2006

(51) Int. Cl. B23B 51/02

(52) U.S. Cl. 408/230

(57) ABSTRACT

A diamond coated drill capable of drilling holes in fiber reinforced composite materials. The drill is made from a tungsten carbide (WC) substrate with cemented cobalt (Co) in a range between about 3 to 10 wt. % and a diamond coating having a thickness in a range between 3 to 20 microns. The drill includes a shank, a longitudinal axis and includes two flutes at a helix angle that is in a range between 25 and 35 degrees with respect to the axis. A margin width is maintained between about 5 to 10 percent of the drill diameter. A body clearance diameter is maintained at between about 92 to 96 percent of the drill diameter. A web thickness before splitting is about 20 to 30 percent of the drill diameter. A clearance angle or lip relief angle is between about 10 and 20 degrees. A chisel edge angle is between about 105 and 120 degrees. A chisel edge length is up to about 0.035 mm. A splitting angle is between about 130 and 150 degrees. A notch angle is between about 30 and 40 degrees with respect to the drill axis. A notch rake angle lies between about −5 and 10 degrees. A split point angle is between about 70 and 100 degrees, and preferably about 90 degrees.

### BACKGROUND OF THE INVENTION

Carbon fiber reinforced plastic (CFRP) consist of a wide range of composite materials with different fiber type, fiber orientation, fiber content, and matrix materials. In recent years, the use of fiber reinforced composite materials has been steadily increasing in many industries. For example, CFRP composite materials have found increasing applications in aerospace and automotive industries due to their high specific strength and specific stiffness. As the use of such materials expands, there will be an increased need for a cost-effective method of producing high quality holes in such materials with dimensions which are within narrow tolerances.

However, CFRP composite materials pose tremendous problems in machining. Currently, the market is dominated by polycrystalline diamond (PCD) drills. Typical defects after drilling using conventional PCD drills include spalling, fiber pull-out, burning, and the like, as shown in FIG. 8.

It has been recognized that spalling and fiber-pull out are caused by the tool thrust. Drill geometry is considered as one of the most important factor affecting tool performance. In addition, due to the high strength of the fiber reinforcement, CFRP is extremely abrasive, which requires tools to have excellent hardness.

Thus, there is a need to provide a drill that minimizes exit hole defects when machining CFRP composite materials.

### BRIEF SUMMARY OF THE INVENTION

Briefly, according to this invention, there is provided a split-point, two-fluted twist drill for machining fiber reinforced composite material. The drill has a lip relief angle between about 10 and 20 degrees; a notch rake angle of between about −5 and 10 degrees; a chisel edge length up to about 0.035 mm; a chisel edge angle of between about 105 and 120 degrees; a splitting angle between about 130 and 150 degrees; and a point angle of between about 70 and 100 degrees.

In another embodiment, a split-point diamond coated twist drill for machining fiber reinforced composite material made of a substrate comprised of tungsten carbide cemented with cobalt in a range between about 3 to 10 wt. %, wherein said drill has a point angle of about 90 degrees.

In yet another embodiment, a split-point, two-fluted, diamond coated twist drill for machining fiber reinforced composite material having a lip relief angle between about 10 and 20 degrees; a notch rake angle of between about −5 and 10 degrees; a chisel edge length less than about 0.035 mm; a point angle of between about 70 and 100 degrees; a helix angle between about 25 and 35 degrees; a web thickness at the point prior to splitting of between about 20 and 30 percent of a drill diameter; a notch angle between about 30 and 40 degrees with respect to a longitudinal axis of the drill; a chisel edge angle between about 105 and 120 degrees; a splitting angle between about 130 and 150 degrees; a body clearance diameter between about 92 and 96 percent of the drill diameter; and a margin width between about 5 to 10 percent of the drill diameter.

### BRIEF DESCRIPTION OF THE DRAWINGS

Further features of the present invention, as well as the advantages derived therefrom, will become clear from the following detailed description made with reference to the drawings in which:

FIG. 1 is a partial perspective view of a drill for machining fiber reinforced composite materials according to an embodiment of the invention;

FIG. 2 is a partial side view of the drill of FIG. 1 showing a point angle;

FIG. 3 is another partial side view of the drill of FIG. 1 showing a relief angle;

FIG. 4 is an enlarged side view of the drill of FIG. 1 showing the notch rake angle;

FIG. 5 is an end view of the drill of FIG. 1 showing a splitting angle, web thickness and margin thickness;

FIGS. 6(a) and 6(b) compares the hole quality produced by a 5 μm diamond coated drill of the invention and a conventional PCD drill when drilling a type A CFRP composite material, respectively;

FIG. 7 compares the hole quality produced by a conventional PCD drill and a diamond coated drill of the invention when drilling a type B CFRP composite material; and

FIG. 8 shows typical defects after drilling using conventional PCD drills.

### DETAILED DESCRIPTION OF THE INVENTION

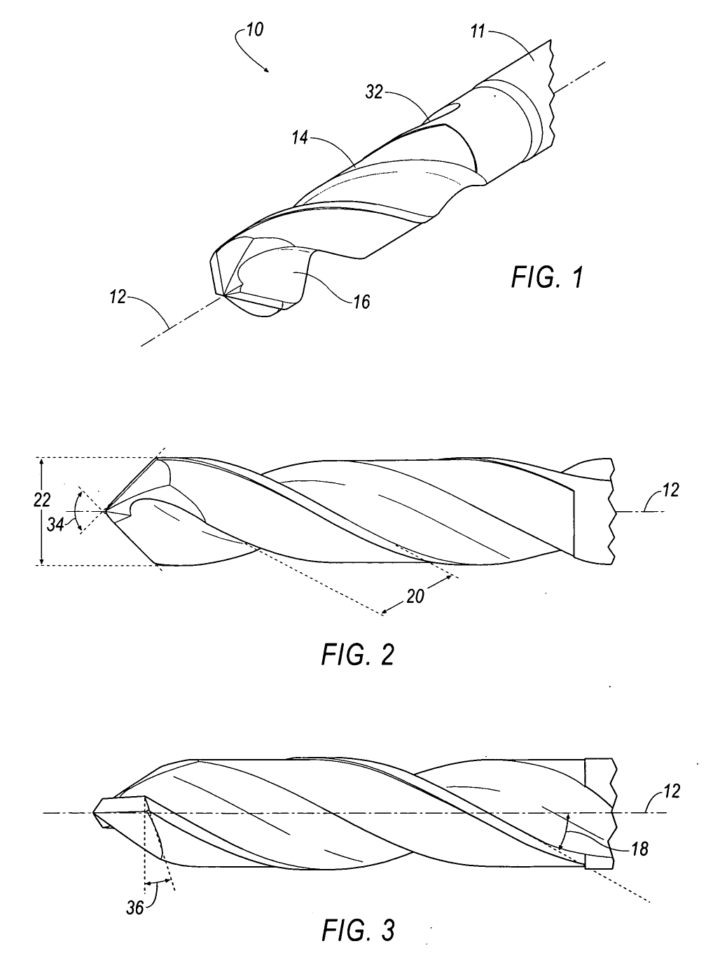

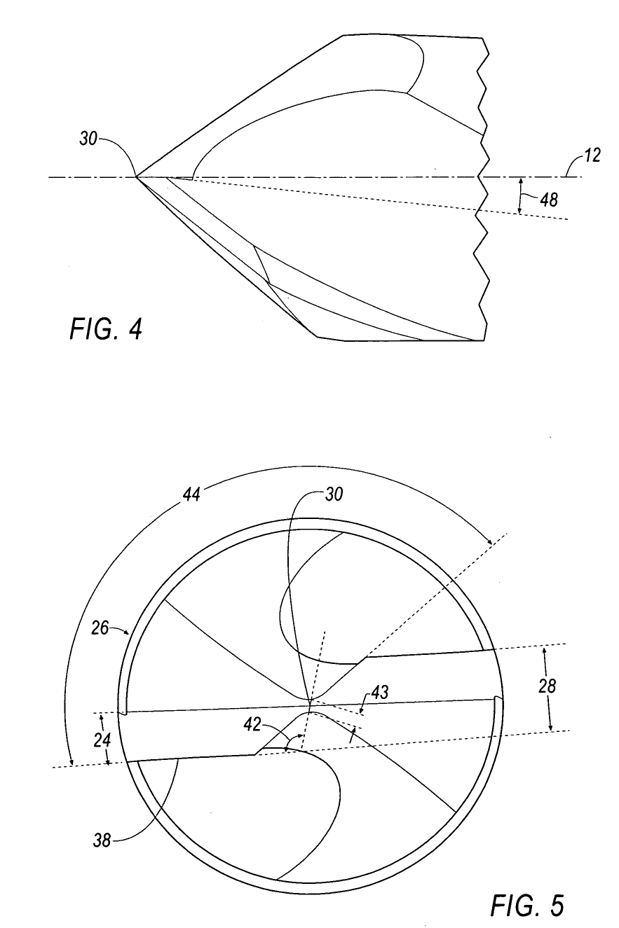

Referring to FIGS. 1-5, wherein like reference characters represent like elements, a two-fluted, diamond coated twist drill prior to splitting is generally shown at 10 according to an embodiment of the invention. Preferably, the drill 10 is made from a tungsten carbide (WC) substrate with cemented cobalt (Co) in a range between about 3 to 10 wt. % and a diamond coating having a thickness in a range between about 3 to 20 μm deposited by using a chemical vapor deposition (CVD) process. The hone radius (or cutting edge radius) is between about 5 to 30 microns after coating.

The drill 10 has a shank 11, a longitudinal axis 12 and includes two flutes, 14 and 16, at a helix angle 18 that is in a range between about 25 and 35 degrees with respect to the longitudinal axis 12. A margin width 24 is maintained between about 5 to 10 percent of the drill diameter 22. A body clearance diameter 26 is maintained at between about 92 to 96 percent of the drill diameter 22. A web thickness 28 (the distance between cutting lips 38 and 40) at the point 30 (before splitting) is about 20 to 30 percent of the drill diameter 22. Point angle 34 is between about 70 and 100 degrees, and preferably about 90 degrees. A clearance angle or lip relief angle 36 is between about 10 and 20 degrees. A chisel edge angle 42 is between about 105 and 120 degrees. A chisel edge length 43 is less than about 0.035 mm. A splitting angle 44 (secondary cutting edge angle) is between about 130 and 150 degrees. A notch angle 46 is between about 30 and 40 degrees with respect to the drill axis 12. A notch rake angle 48 lies between about −5 and 10 degrees.

Drill Geometry

The geometry of the drill 10 of the invention was tested and compared with a number of different geometries as listed in Table 1. The results of the comparison shows that the brad and spur point geometry and the 90-degree split point drill geometry demonstrated the results of the smallest exit hole defect size. However, the brad and spur point drill had chipping issues, and hence had a reduced tool life. Moreover, the brad and spur point drill is more difficult to grind, and its sharp edges make it unsuitable for coating. Thus, the 90-degree split point drill geometry demonstrated the best overall performance and results.

TABLE I
Drills of Different Geometry and Corresponding Hole Defect Size

| Drill Geometry | Hole Defect Size (inch) |
|---|---|
| Brad and spur point | 0.05 |
| HP point | 0.12 |
| TX point (straight fluted) | 0.13 |
| 90-degree split point | 0.09 |
| 135 degree split point | 0.15 |
| 185/90/70 degree split point | 0.10 |

CVD Diamond Coatings

The performance of the drill 10 of the invention on two types of carbon fiber reinforced plastic (CFRP) composite materials (namely, type A and B) that are being used in aircraft skin was evaluated. In particular, the 90-degree split point drill geometry was employed in this evaluation. Diamond coatings of two different thicknesses were deposited on drill substrate made of tungsten carbide (WC) with 6 wt. % cobalt (Co) by using a chemical vapor deposition (CVD) method. It will be appreciated that the invention is not limited by the particular weight percent of cobalt, and that the invention can be practiced with a WC substrate with cemented cobalt in a range of between about 3 to 10 wt. % cobalt. The conventional polycrystalline diamond (PCD) drill is currently the dominant product on the market for CFRP drilling. The radius of the cutting edge and the thrust when drilling the first hole are listed in Table II. As shown in Table II, the 90-degree split point drill geometry produced smaller thrust and sharper cutting edge, which is beneficial to hole quality, as observed by the inventors.

TABLE II
Drill Geometry, Cutting Edge Radius and Thrust

| | | | Thrust in drilling | Thrust in drilling |
|---|---|---|---|---|
| Drill Type | Geometry | Edge radius (μm) | Type A CFRP (lbs) | Type B CFRP (lbs) |
| PCD | PCD veined | 15 to 25 | 13.0 | 12.6 |
| | multifaceted point, | | | |
| | helical fluted | | | |
| As ground - 90° | 90° split point | 10 to 20 | 11.4 | N/A |
| split point drill | | | | |
| 5 μm diamond | 90° split point | 10 to 20 | 12.4 | 12.2 |
| coated 90° split | | | | |
| point drill | | | | |
| 12 μm diamond | 90° split point | 10 to 20 | 10.1 | 10.3 |
| coated 90° split | | | | |
| point drill | | | | |

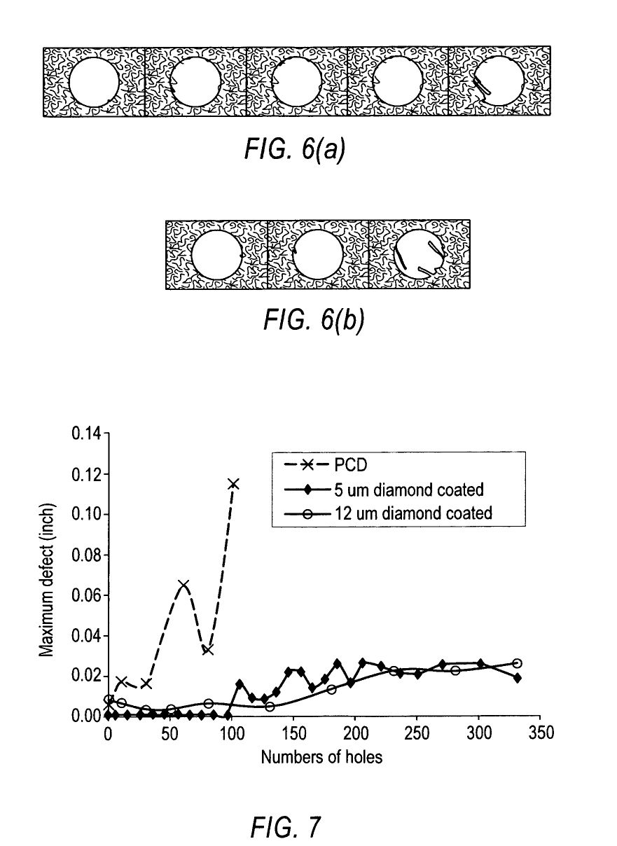

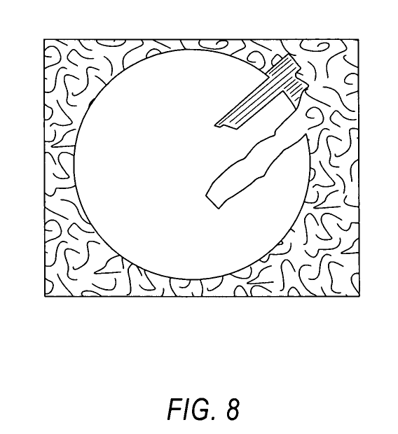

FIGS. 6(a) and (b) compare the hole quality produced by a 5 μm diamond coated drill of the invention and a conventional polycrystalline diamond (PCD) drill when drilling a type A carbon fiber reinforced plastic (CFRP) composite material, respectively. As shown, the 5 μm diamond coated drill of the invention produced unexpected results of much better hole quality than the conventional PCD drill. Moreover, the 5 μm diamond coated drill of the invention produced unexpected results by outperforming the conventional PCD drill in tool life (97 holes vs. 50 holes). As a comparison, the uncoated WC-6 wt. % drill can only make 10 quality holes due to severe abrasive wear by carbon fibers.

It will be appreciated that the drill of the invention is not limited by the thickness of the diamond coating. For example, the drill of the invention can be made of a WC substrate with a diamond coating thickness in a range between about 3 to 20 μm. Further, it will be appreciated that the drill of the invention can be practiced with a radius of the cutting edge in a range between about 5 to 30 μm.

FIG. 7 compares the hole quality produced by PCD drill and diamond coated drills when drilling a type B CFRP composite material. Both the 5 μm and 12 μm diamond coated drills produced unexpected results by outperforming the conventional PCD drill in hole quality and tool life.

As described above, the split-point, two-fluted twist drill 10 of the invention with a WC-6 wt. % Co substrate and either a 5 μm of a 12 μm diamond coating produced unexpected results by outperforming a conventional polycrystalline diamond (PCD) drill when machining fiber reinforced composite material, such as a Type A and B carbon fiber reinforced plastic (CFRP) composite material. Further, the invention is not limited to a drill for machining CFRP composite material. For example, the drill of the invention can be used for machining glass fiber reinforced material, and the like. In addition, the drill of the invention can be used in dry or wet environments.

The documents, patents and patent applications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

What is claimed is:

1. A split-point, two-fluted, diamond coated twist drill for machining fiber reinforced composite material having a lip relief angle between about 10 and 20 degrees; a notch rake angle of between about −5 and 10 degrees; a chisel edge length less than about 0.035 mm; and a point angle of between about 70 and 100 degrees.

2. The drill according to claim 1, wherein the point angle is about 90 degrees.

3. The drill according to claim 1, further including a helix angle of said flutes between about 25 and 35 degrees.

4. The drill according to claim 1, further including a web thickness at the point prior to splitting of between about 20 and 30 percent of a drill diameter.

5. The drill according to claim 1, further including a notch angle between about 30 and 40 degrees with respect to a longitudinal axis of said drill.

6. The drill according to claim 1, further including a chisel edge angle between about 105 and 120 degrees.

7. The drill according to claim 1, further including a splitting angle between about 130 and 150 degrees.

8. The drill according to claim 1, further including a body clearance diameter between about 92 and 96 percent of a drill diameter.

9. The drill according to claim 1, further including a margin width between about 5 to 10 percent of a drill diameter.

10. A split-point, diamond coated twist drill for machining fiber reinforced composite material made of a substrate comprised of tungsten carbide cemented with cobalt in a range between about 3 to 10 wt. %, wherein said drill has a point angle of about 90 degrees.

11. The drill according to claim 10, wherein the diamond coating has a thickness in a range between about 3 to 20 μm.

12. The drill according to claim 11, wherein the thickness of the diamond coating is about 5 μm.

13. The drill according to claim 11, wherein the thickness of the diamond coating is about 12 μm.

14. The drill according to claim 10, further including a hone radius of between about 5 to 30 microns.

15. The drill according to claim 10, wherein the cobalt is about 6 wt. %.

16. The drill according to claim 10, further including a lip relief angle between about 10 and 20 degrees; a notch rake angle of between about −5 and 10 degrees; and a chisel edge length less than about 0.035 mm.

17. The drill according to claim 16, further including two flutes having a helix angle between about 25 and 35 degrees.

18. The drill according to claim 16, further including a web thickness at the point prior to splitting of between about 20 and 30 percent of a drill diameter.

19. The drill according to claim 16, further including a notch angle between about 30 and 40 degrees with respect to a longitudinal axis of said drill.

20. The drill according to claim 16, further including a chisel edge angle between about 105 and 120 degrees.

21. The drill according to claim 16, further including a splitting angle between about 130 and 150 degrees.

22. The drill according to claim 16, further including a body clearance diameter between about 92 and 96 percent of a drill diameter.

23. The drill according to claim 16, further including a margin width between about 5 to 10 percent of a drill diameter.

24. A split-point, two-fluted, diamond coated twist drill for machining fiber reinforced composite material having a lip relief angle between about 10 and 20 degrees; a notch rake angle of between about −5 and 10 degrees; a chisel edge length less than about 0.035 mm; a point angle of between about 70 and 100 degrees; a helix angle between about 25 and 35 degrees; a web thickness at the point prior to splitting of between about 20 and 30 percent of a drill diameter; a notch angle between about 30 and 40 degrees with respect to a longitudinal axis of said drill; a chisel edge angle between about 105 and 120 degrees; a splitting angle between about 130 and 150 degrees; a body clearance diameter between about 92 and 96 percent of the drill diameter; and a margin width between about 5 to 10 percent of the drill diameter.

25. The drill according to claim 24, wherein the diamond coating has a thickness in a range between about 3 to 20 μm.

26. The drill according to claim 25, wherein the thickness of the diamond coating is about 5 μm.

27. The drill according to claim 25, wherein the thickness of the diamond coating is about 12 μm.
